(19) United States
(12) Patent Application Publication
(10) Pub. No.: US 2013/0056088 A1
(43) Pub. Date: Mar. 7, 2013

(54) Frost Proof Sillcock System

(71) Applicant: James E. Grisham, Eldon, MO (US)

(72) Inventor: James E. Grisham, Eldon, MO (US)

(21) Appl. No.: 13/598,807

(22) Filed: Aug. 30, 2012

Related U.S. Application Data
(60) Provisional application No. 61/529,993, filed on Sep. 1, 2011.

(51) Int. Cl. F16K 17/14

(52) U.S. Cl. 137/68.19

(57) ABSTRACT

A frost proof sillcock system for diverting water away from a building when a tubular body of a sillcock is broken and allowing an individual to easily repair a broken sillcock. The frost proof sillcock system generally includes an outer tube fluidly connected to a supply pipe within a building and a sillcock removably connected within the outer tube. If the sillcock ruptures, the water is diverted outside of the building by the outer tube. The sillcock is replaced by rotating the sillcock to disconnect from the outer tube thereby allowing a replacement sillcock to be installed.

### CROSS REFERENCE TO RELATED APPLICATIONS

I hereby claim benefit under Title 35, United States Code, Section 119(e) of U.S. provisional patent application Ser. No. 61/529,993 filed Sep. 1, 2011. The 61/529,993 application is currently pending. The 61/529,993 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a frost proof sillcock and more specifically it relates to a frost proof sillcock system for diverting water away from a building when a tubular body of a sillcock is broken and allowing an individual to easily repair a broken sillcock.

2. Description of the Related Art

Any discussion of the related art throughout the specification should in no way be considered as an admission that such related art is widely known or forms part of common general knowledge in the field.

Frost proof sillcocks are utilized in geographical areas where freezing temperatures are encountered. A frost proof sillcock is designed so that the valve is positioned inside the building and thereby stops the flow of water inside of the building that is not subject to freezing temperatures. The handle and the spout are positioned outside of the building, with the tubular body of the frost proof sillcock extending into the interior of the building to be fluidly connected to the water supply of the building. A properly installed frost proof sillcock will angled downwardly toward the spout so that water within the tubular body may be drained when the valve is closed. U.S. Pat. No. 4,022,243 to Edwards illustrates a conventional frost proof sillcock.

One problem with conventional frost proof sillcocks is that they are still susceptible to freezing up when a hose or other device is fluidly connected to the spout thereby preventing drainage of the water from the tubular body. When water within a conventional frost proof sillcock freezes, the tubular body is subject to being ruptured and when the user turns the water one via the handle the water escapes via the rupture into the interior of the building causing water damage. Another problem with conventional sillcocks is that replacing them is difficult, costly and time consuming typically requiring the services of a plumber.

Because of the inherent problems with the related art, there is a need for a new and improved frost proof sillcock system for diverting water away from a building when a tubular body of a sillcock is broken and allowing an individual to easily repair a broken sillcock.

### BRIEF SUMMARY OF THE INVENTION

The invention generally relates to a frost proof sillcock which includes an outer tube fluidly connected to a supply pipe within a building and a sillcock removably connected within the outer tube. If the sillcock ruptures, the water is diverted outside of the building by the outer tube. The sillcock is replaced by rotating the sillcock to disconnect from the outer tube thereby allowing a replacement sillcock to be installed.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a front upper perspective view of the present invention installed within a building.

FIG. 2 is a front upper perspective view of the present invention.

FIG. 3 is an exploded front upper perspective view of the present invention.

FIG. 4 is an exploded side cutaway view of the present invention.

FIG. 5 is a partially exploded side cutaway view of the present invention.

FIG. 6 is a side cutaway view of the present invention installed within a building.

FIG. 7 is a side cutaway view of the present invention illustrating a ruptured frost proof sillcock with the water flowing outside of the building.

### DETAILED DESCRIPTION OF THE INVENTION

### A. Overview.

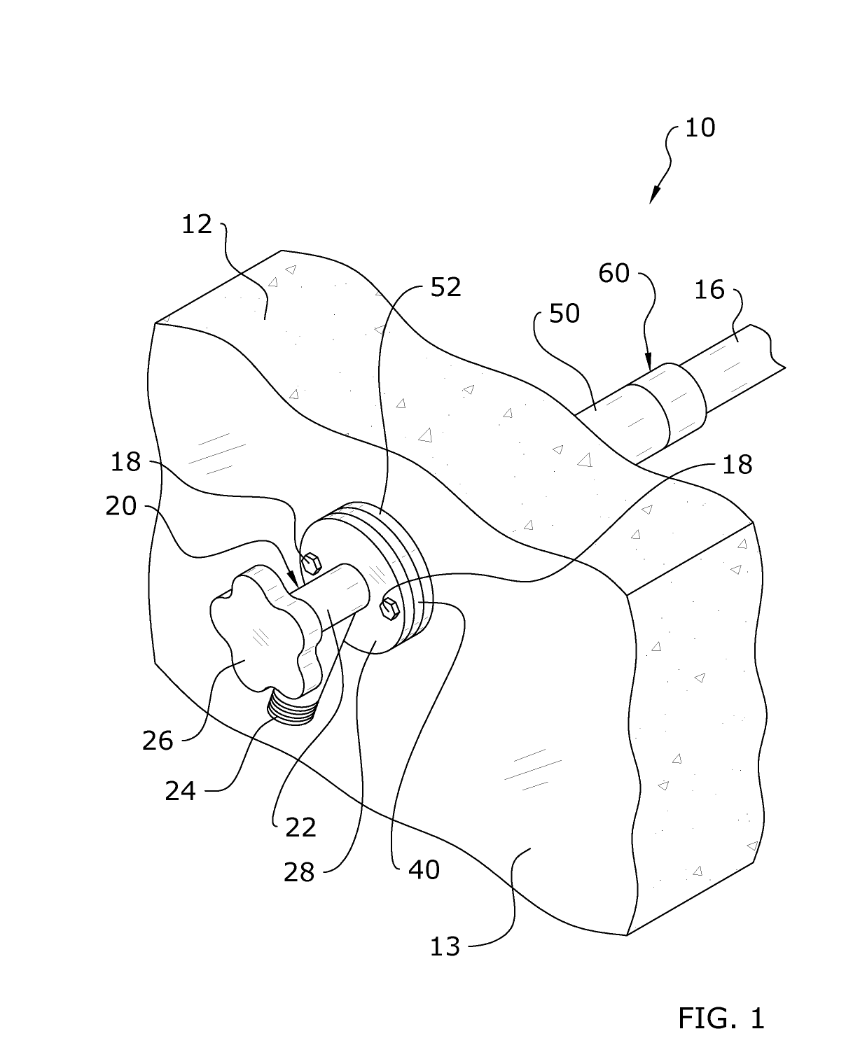

Turning now descriptively to the drawings, in which similar reference characters denote similar elements throughout the several views, FIGS. 1 through 6 illustrate a frost proof sillcock system 10, which comprises an outer tube 50 fluidly connected to a supply pipe 16 within a building and a sillcock 20 removably connected within the outer tube 50. If the sillcock 20 ruptures, the water 11 is diverted outside of the building by the outer tube 50. The sillcock 20 is replaced by rotating the sillcock 20 to disconnect from the outer tube 50 thereby allowing a replacement sillcock 20 to be installed.

### B. Outer Tube.

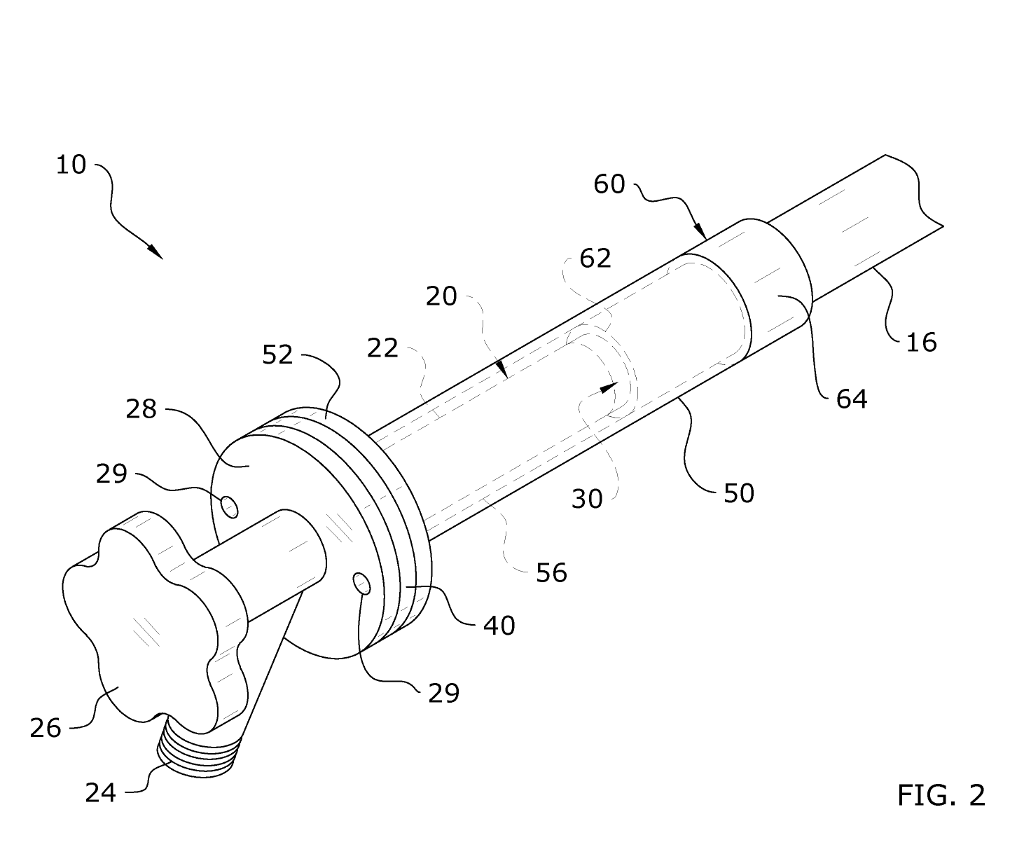

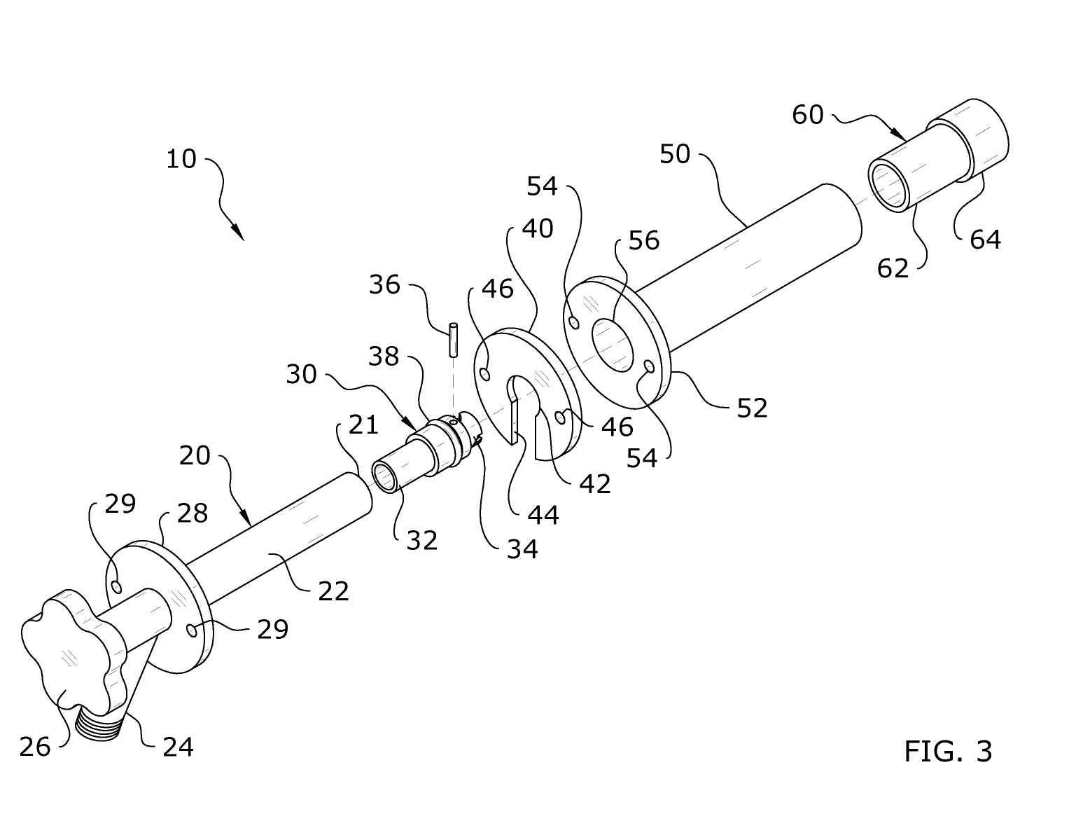

FIGS. 2 and 3 best illustrate the outer tube 50 which is comprised of an elongated structure. The outer tube 50 may be comprised of various materials such as but not limited to metal, plastic or composite materials. It is preferable that the outer tube 50 has a circular cross sectional shape to correspond with conventional sillcocks 20 that typically have a circular inner tube 22. However, the outer tube 50 may have various cross sectional shapes such as but not limited to square, rectangular, oval, hexagonal and the like.

The outer tube 50 has a length sufficient to extend completely through a wall 12 from the outside surface 13 thereof to the inside surface 14 of the wall 12 as illustrated in FIGS. 1, 5, 6 and 7 of the drawings. When installed within a wall 12, the outer tube 50 preferably is included downwardly from the inside surface 14 to the outside surface 13 of the water 11 to facilitate draining of the outer tube 50 and the sillcock 20.

The outer tube 50 includes an outer opening 56 that is exposable outside of a wall 12. The outer opening 56 discharges water 11 that is received within the outer tube 50 because of a ruptured sillcock 20 due to freezing or other type of damage. For example, if the sillcock 20 incurs a ruptured opening 15 due to freezing of water 11, building movement or other cause, water 11 flowing from the ruptured opening 15 is diverted outside of the building through the interior of the outer tube 50 to outwardly from the outer opening 56 of the outer tube 50 instead of into the wall 12 or inside of the building.

The interior width of the interior of the outer tube 50 is larger than the exterior width of the sillcock 20 to provide a space for water 11 to be received and discharged from within the interior of the outer tube 50 when the sillcock 20 is damaged resulting a ruptured opening 15. The space between the outer tube 50 and the inner tube 22 is preferably sufficient to allow a normal unobstructed flow of water 11 from the sillcock 20.

The outer tube 50 is fluidly connectable to a supply pipe 16 within a building to provide pressurized water 11 to the sillcock 20 as illustrated in FIGS. 1, 2, 5, 6 and 7 of the drawings. The supply pipe 16 may be directly connected to the outer tube 50 or a second coupler 60 may be connected between the supply pipe 16 and the outer tube 50. If a second coupler 60 is used, the second coupler 60 may be integrally formed within the outer tube 50 or attached to the outer tube 50.

The outer tube 50 includes an inner flange 52 that is positioned outside of the wall 12 of the building preferably adjacent to the outside surface 13 of the wall 12 as best illustrated in FIGS. 3, 5, 6 and 7 of the drawings. The inner flange 52 preferably extends around the entire outer opening 56 of the outer tube 50 as illustrated in FIG. 3 of the drawings, however, the inner flange 52 may only partially extend around the outer opening 56 of the outer tube 50. For example, the inner flange 52 could extend from a lower-middle portion to an upper end of the outer tube 50 thereby leaving a discharge port for the water 11 to escape from in the lower portion of the outer opening 56. The inner flange 52 preferably includes a pair of third apertures 54 that are aligned with the first apertures 29 of the outer flange 28 and the second apertures 46 of the spacer 40 to receive corresponding fasteners 18 to secure the same to the wall 12.

### C. Sillcock

The sillcock 20 may be comprised of any conventional outdoor faucet capable of dispensing water 11 for outdoor watering needs (e.g. watering a garden, watering a lawn, washing a vehicle, cleaning a building, providing water 11 to animals, etc.). The sillcock 20 is preferably comprised of a frost proof sillcock 20 wherein the control valve 25 is positioned within a warmer area of the building to prevent freezing of the water 11 behind the control valve 25. U.S. Pat. No. 4,022,243 to Edwards illustrates a conventional frost proof sillcock 20 and is hereby incorporated by reference.

The sillcock 20 includes a spout 24 (preferably male threaded) for connecting a hose 19 or other outdoor irrigation device to the spout 24. The sillcock 20 further includes a handle 26 connected to a valve stem 23 that extends through the inner tube 22, wherein the valve stem 23 is connected to the control valve 25 to open and close the control valve 25. As is well known in the technology of sillcocks 20, when the user rotates the handle 26, the valve stem 23 is rotated thereby causing the control valve 25 to open and close based upon the direction of rotation. The sillcock 20 further preferably includes an outer flange 28 that includes a pair of first apertures 29 as illustrated in FIG. 3 of the drawings. The inner tube 22 of the sillcock 20 is comprised of an elongated tube that is fluidly connected between the spout 24 and the outer tube 50 to provide pressurized water 11 from the supply pipe 16 to the spout 24 as controlled by the handle 26.

The sillcock 20 is preferably removably positioned and fluidly connected within the interior of the outer tube 50 as illustrated in FIGS. 1, 2, 6 and 7 of the drawings. While it is preferable that the sillcock 20 is removably positioned within the outer tube 50, it can be appreciated that non-removable versions may be utilized in combination with the outer tube 50.

The sillcock 20 is preferably concentrically positioned within the outer tube 50 as best illustrated in FIGS. 2, 5, 6 and 7 of the drawings. The inner tube 22 of the sillcock 20 is positioned within the interior of the outer tube 50 with the inner end 21 of the sillcock 20 fluidly connected to and sealed with respect to the outer tube 50. The exterior perimeter of the inner tube 22 is distally spaced from an interior perimeter of the outer tube 50 to provide a passage for the water 11 to flow out of in the event a ruptured opening 15 within the inner tube 22 is created.

### D. Couplers.

The sillcock 20 includes a first coupler 30 which may be integrally formed or attached to the inner end 21 of the inner tube 22 as illustrated in FIGS. 3 through 7 of the drawings. The outer tube 50 includes a second coupler 60 which may be integrally formed or attached to the end of the outer tube 50 opposite of the inner flange 52 as illustrated in FIGS. 1 through 7 of the drawings.

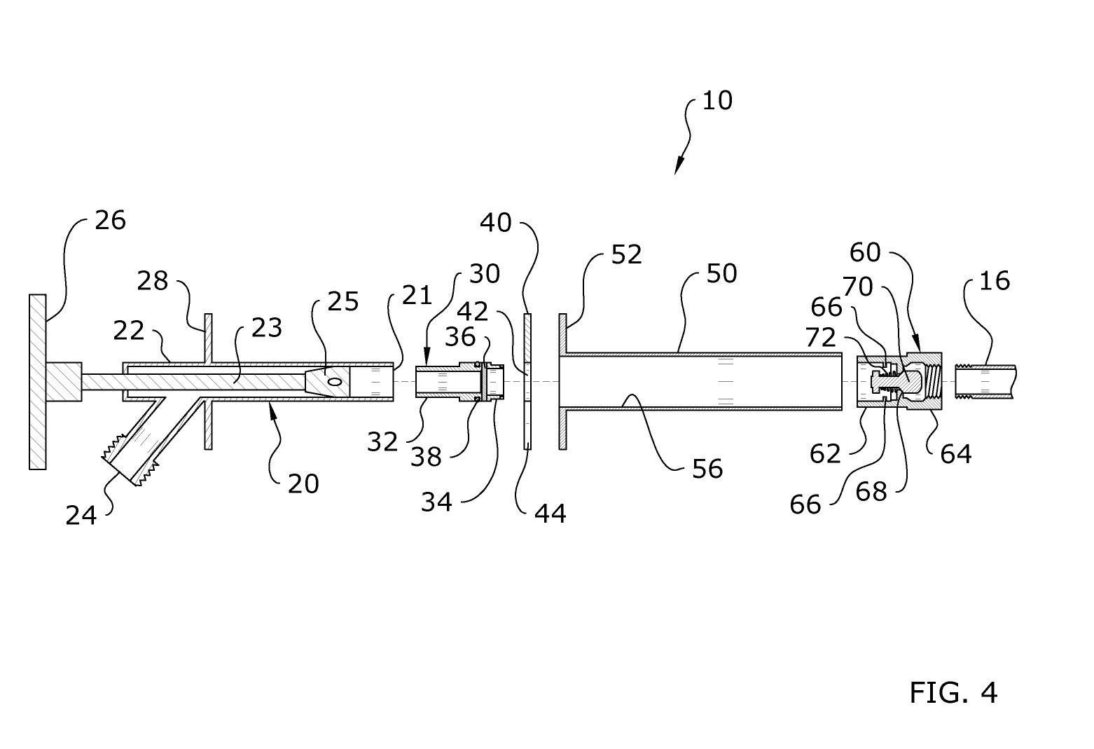

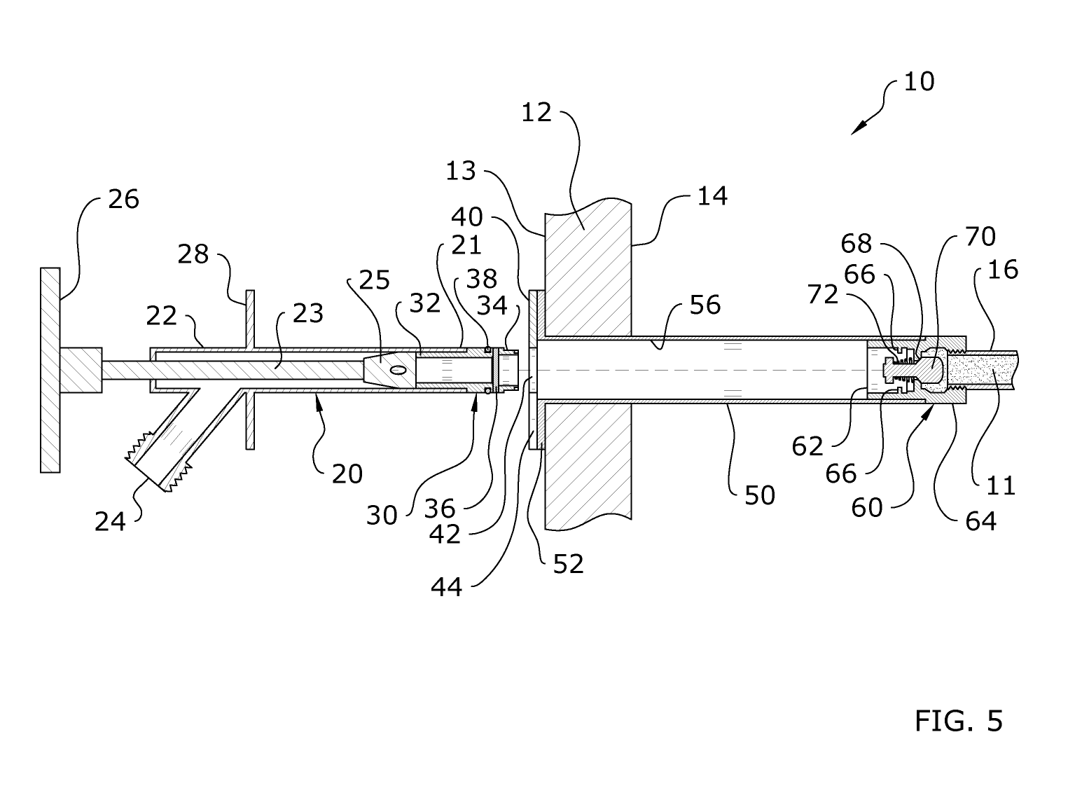

The first coupler 30 is removably and fluidly connectable to the second coupler 60 as illustrated in FIGS. 5 through 7 of the drawings. The first coupler 30 includes a first coupler end 32 that preferably extends into the inside of the inner end 21 of the sillcock 20 as illustrated in FIGS. 4 and 5 of the drawings. The second coupler 60 includes a first end 62 that is positioned within the outer tube 50 and a second end 64 opposite of the first end 62 that fluidly connects to the supply pipe 16. The supply pipe 16 maybe an pipe within the building that supplies water 11.

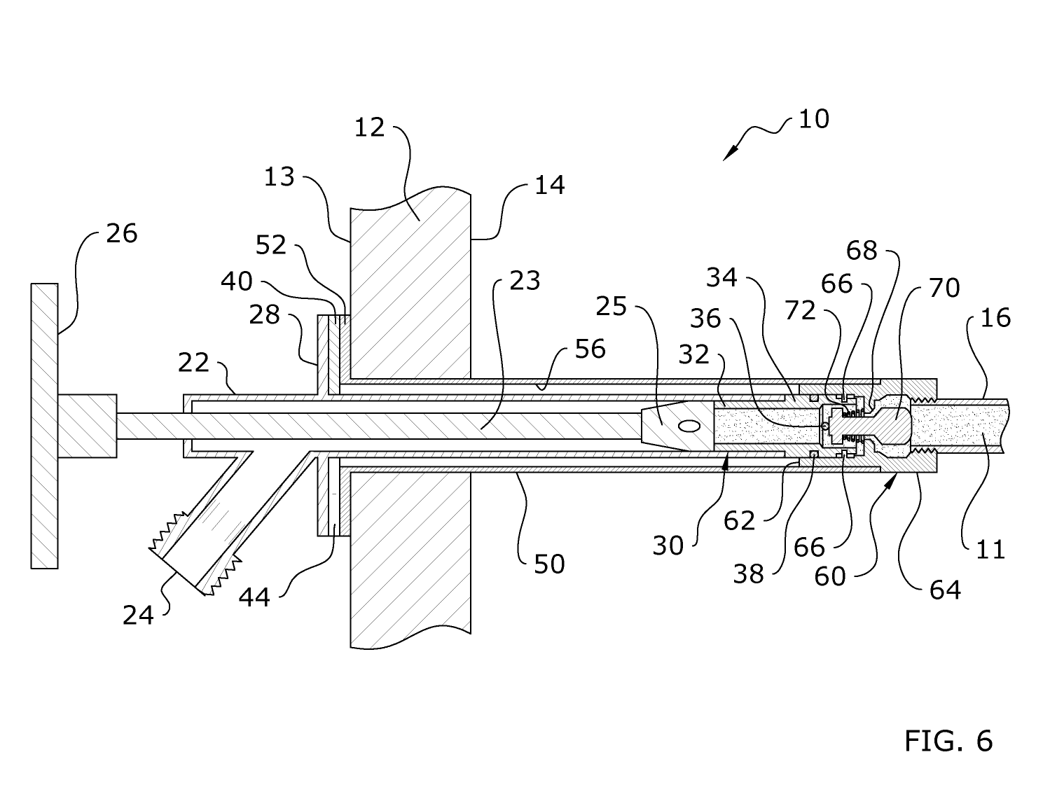

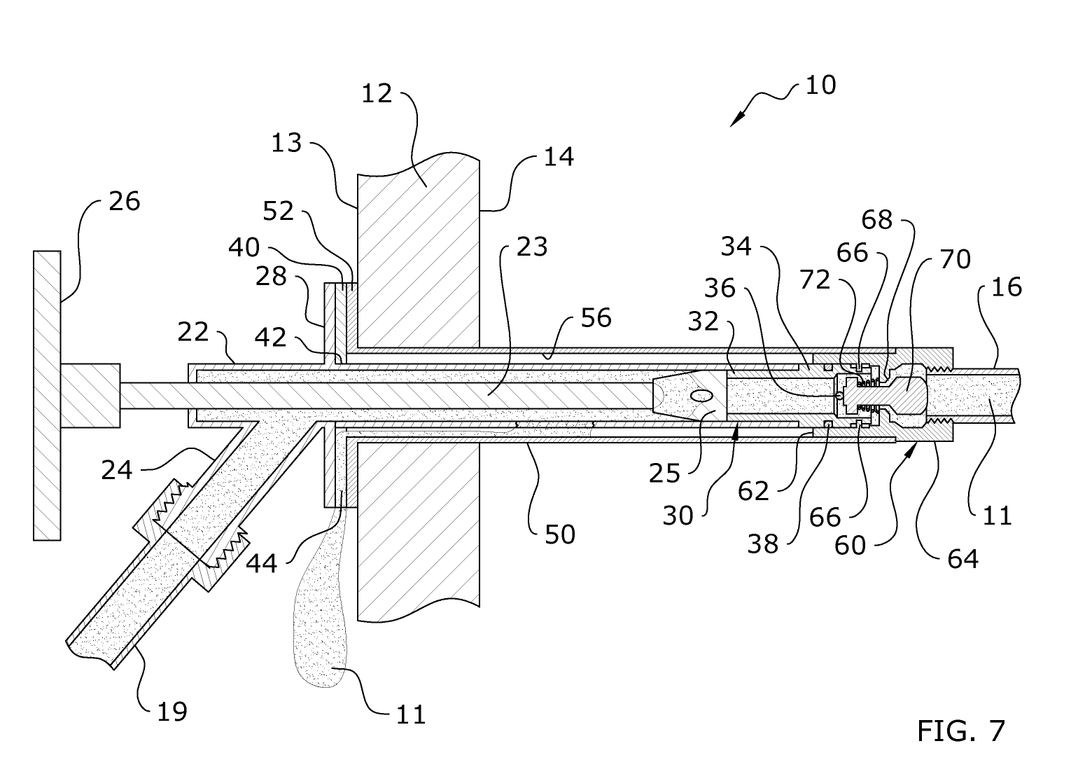

A seal 38 (e.g. O-ring) is attached to the perimeter of the second coupler end 34 of the first coupler 30 to form a seal 38 within the interior surface of the outer tube 50 or the interior passage of the second coupler 60 when the sillcock 20 is installed within the outer tube 50 as illustrated in FIGS. 6 and 7 of the drawings. The seal 38 prevents the passage of water 11 around the connection of the first coupler 30 and the second coupler 60.

The first coupler 30 and the second coupler 60 are preferably comprised of quick couplers to allow for the efficient removal of an existing sillcock 20 and replacement with a new sillcock 20. The first coupler 30 is preferably rotatably connected and disconnected with respect to the second coupler 60 by a connecting member 66 (e.g. threading, inwardly extending portion) of the second coupler 60 engaging a helical groove or channel within the second coupler end 34 of the first coupler 30.

### E. Check Valve.

A check valve 70 is fluidly connected to the outer tube 50. The check valve 70 may be directly connected within the outer tube 50 or connected within the second coupler 60 as illustrated in FIGS. 4 through 7 of the drawings. The check valve 70 is opened when the sillcock 20 is connected to the outer tube 50 wherein an engaging member 36 within the first coupler 30 engages the check valve 70 thereby allowing water 11 to flow from the supply pipe 16 to the sillcock 20. The check valve 70 is closed when the sillcock 20 is disconnected from the outer tube 50 thereby preventing water 11 to flow from the supply pipe 16 to the sillcock 20 thereby allowing replacement of the sillcock 20 without having to turn off the water 11 inside of the building (e.g. house, commercial building). As illustrated in FIGS. 6 and 7, the check valve 70 is opened when the first coupler 30 is connected to the second coupler 60 thereby allowing water 11 to flow from the supply pipe 16 to the sillcock 20. As illustrated in FIG. 5 of the drawings, the check valve 70 is closed when the first coupler 30 is disconnected from the second coupler 60 thereby preventing water 11 to flow from the supply pipe 16 to the sillcock 20.

FIGS. 4 through 7 illustrate an exemplary check valve 70 having a bulbous shape that fits within a valve seat 68 within the second coupler 60 and includes a bias member 72 (e.g. spring) forcing the check valve 70 closed. However, various other types of check valves 70 may be utilized such as but not limited to a ball check valve 70, a diaphragm check valve 70, a swing check valve 70, or a stop-check valve 70.

### F. Spacer.

FIG. 3 best illustrates the spacer 40 having a center opening 42 positionable over the sillcock 20 and a discharge opening 44 extending downwardly forming a C-shaped structure. The center opening 42 is sufficient in size to receive the inner tube 22 of the sillcock 20 as illustrated in FIGS. 6 and 7 of the drawings. The discharge opening 44 extends downwardly to the exterior perimeter of the spacer 40. The spacer 40 may be comprised of various types of materials such as but not limited to plastic, metal and composite material.

The spacer 40 is positioned between the inner flange 52 of the outer tube 50 and the outer flange 28 of the sillcock 20 to provide sufficient space for the water 11 discharged through the interior of the outer tube 50 to escape outwardly through the discharge opening 44. The discharge opening 44 preferably extends downwardly thereby allowing all or at least a significant portion of the water 11 within the interior of the outer tube 50 to flow out via gravity thereby preventing the accumulation of water 11 within the outer tube 50. The thicker the spacer 40 is, the greater the discharge opening 44 will be, so either the spacer 40 may have an increased thickness or more than one spacer 40 may be utilized.

### G. Operation of Preferred Embodiment.

In use, the user creates a hole within the wall 12 of the building (either new construction or existing construction) sufficient in size to receive the outer tube 50. The hole is preferably angled downwardly from the inside surface 14 of the wall 12 to the outside surface 13 of the wall 12 to facilitate draining of water 11 from the sillcock 20 and the outer tube 50. The outer tube 50 is inserted through the wall 12 until the inner flange 52 engages the outside surface 13 of the wall 12 as illustrated in FIG. 5 of the drawings. The user then fluidly connects the supply pipe 16 from within the building to the second coupler 60 of the outer tube 50 (wherein the supply pipe 16 is initially closed for the flow of water 11 by closing the appropriate valve) as further shown in FIG. 5 of the drawings. As discussed previously, the supply pipe 16 may be connected directly to the outer tube 50 utilizing various connecting systems (e.g. threaded connection, brazing, welding, etc.) or indirectly via the second coupler 60 which is illustrated in FIGS. 4 through 7 of the drawings.

After the outer tube 50 is properly positioned within the wall 12, the user then positions the spacer 40 over the sillcock 20 and then inserts the inner tube 22 of the sillcock 20 into the interior of the outer tube 50 as illustrated in FIGS. 6 and 7 of the drawings. The user presses the sillcock 20 inwardly such that the first coupler 30 engages the second coupler 60. The user then rotates sillcock 20 approximately ninety-degrees clockwise resulting in the first coupler 30 mating with the second coupler 60. As the first coupler 30 mates with the second coupler 60 drawing the first coupler 30 inwardly with respect to the second coupler 60, an engaging member 36 (e.g. a pin extending crosswise within the first coupler 30) engages an end portion of the check valve 70 forcing the check valve 70 open against the biasing force of the bias member 72 as illustrated in FIGS. 6 and 7 of the drawings. The user then secures the present invention by extending fasteners 18 (e.g. bolts, screws) through the apertures 29, 46, 54 into the wall 12 thereby preventing movement of the sillcock 20 and the outer tube 50.

The user may utilize the sillcock 20 as they normally would by rotating the handle 26 counterclockwise to dispense water 11 through the spout 24 and clockwise to stop the flow of water 11 which opens/closes the control valve 25 within the sillcock 20 respectively. As illustrated in FIGS. 6 and 7 of the drawings, the control valve 25 is still positioned within a warm position within the building but is inside of the position of the check valve 70. The user may also attached a hose 19 or other fluid transfer device to the male threading of the spout 24 (or connecting to the spout 24 via a different connection system) as illustrated in FIG. 7 of the drawings.

In a situation where the user leaves the sillcock 20 turned on thereby providing water 11 throughout the inner tube 22, the spout 24 and the hose 19, a ruptured opening 15 can occur when the water 11 within the inner tube 22 becomes frozen as illustrated in FIG. 7 of the drawings. A ruptured opening 15 can also occur in situations where the sillcock 20 is turned off but the hose 19 is left attached to the spout 24 thereby preventing the draining of the sillcock 20 which in turn keeps water 11 within the inner tube 22, the spout 24 and the hose 19 which can result in a ruptured opening 15 within the inner tube 22 as illustrated in FIG. 7 of the drawings. Once the inner tube 22 has a ruptured opening 15, water 11 provided from the supply pipe 16 is allowed to escape through the ruptured opening 15 (assuming the control valve 25 is turned on). The water 11 that escapes through the ruptured opening 15 is collected and transferred within the interior of the outer tube 50 to outside of the building via the outer opening 56 and the discharge opening 44 within the spacer 40 as illustrated in FIG. 7. By discharging the water 11 from the ruptured opening 15 outside of the building, the damage to the building from the water 11 is prevented which ordinarily would have happened with a conventional system.

After the user determines the sillcock 20 is damaged, they can easily replace the sillcock 20 by removing the fasteners 18 and then rotating the sillcock 20 approximately ninety-degrees counter-clockwise thereby releasing the first coupler 30 from the second coupler 60. Once the first coupler 30 is released from the second coupler 60, the engaging member 36 is removed from the check valve 70 thereby allowing the bias member 72 to force the check valve 70 closed thereby preventing the flow of water 11 from the supply line until the sillcock 20 is replaced. The check valve 70 also prevents the user from having to find the appropriate valve within the building and closing the valve to stop the flow of water 11 which is conventionally done. The user then replaces the sillcock 20 by inserting a replacement sillcock 20 into the outer tube 50 such that the first coupler 30 is fully connected to the second coupler 60 thereby allowing continued operation of the sillcock 20.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A frost proof sillcock, comprising:
an outer tube having an outer opening, fluidly connectable to a supply pipe within a building; and
a sillcock removably positioned and fluidly connected within an interior of said outer tube, wherein if said sillcock incurs a ruptured opening, water flowing from the ruptured opening is diverted outside of the building through said interior of said outer tube to outwardly from said outer opening of said outer tube.

2. The frost proof sillcock of claim 1, wherein said sillcock is comprised of a frost proof sillcock.

3. The frost proof sillcock of claim 1, wherein said outer opening is exposable outside of a wall.

4. The frost proof sillcock of claim 1, including a spacer having a center opening positionable over said sillcock, a discharge opening extending downwardly, wherein said outer tube includes an inner flange, wherein said sillcock includes an outer flange and wherein said spacer is positioned between said inner flange and said outer flange.

5. The frost proof sillcock of claim 1, wherein said sillcock includes a first coupler and wherein said outer tube includes a second coupler, wherein said first coupler is removably and fluidly connectable to said second coupler.

6. The frost proof sillcock of claim 5, wherein said first coupler and said second coupler are comprised of quick couplers.

7. The frost proof sillcock of claim 5, wherein said first coupler is rotatably connected and disconnected with respect to said second coupler.

8. The frost proof sillcock of claim 5, including a check valve fluidly connected to said outer tube, wherein said check valve is opened when said first coupler is connected to said second coupler thereby allowing water to flow from the supply pipe to said sillcock, and wherein said check valve is closed when said first coupler is disconnected from said second coupler thereby preventing water to flow from the supply pipe to said sillcock.

9. The frost proof sillcock of claim 1, wherein said sillcock is concentrically positioned within said outer tube.

10. The frost proof sillcock of claim 1, wherein an inner tube of said sillcock is positioned within said interior of said outer tube, wherein an exterior perimeter of said inner tube is distally spaced from an interior perimeter of said outer tube.

11. A frost proof sillcock, comprising:
an outer tube having an outer opening, fluidly connectable to a supply pipe within a building;
a sillcock removably positioned and fluidly connected within an interior of said outer tube, wherein if said sillcock incurs a ruptured opening, water flowing from the ruptured opening is diverted outside of the building through said interior of said outer tube to outwardly from said outer opening of said outer tube; and
a check valve fluidly connected to said outer tube, wherein said check valve is opened when said sillcock is connected to said outer tube thereby allowing water to flow from the supply pipe to said sillcock, and wherein said check valve is closed when said sillcock is disconnected from said outer tube thereby preventing water to flow from the supply pipe to said sillcock.

12. The frost proof sillcock of claim 11, wherein said sillcock is comprised of a frost proof sillcock.

13. The frost proof sillcock of claim 11, wherein said outer opening is exposable outside of a wall.

14. The frost proof sillcock of claim 11, including a spacer having a center opening positionable over said sillcock, a discharge opening extending downwardly, wherein said outer tube includes an inner flange, wherein said sillcock includes an outer flange and wherein said spacer is positioned between said inner flange and said outer flange.

15. The frost proof sillcock of claim 11, wherein said sillcock includes a first coupler and wherein said outer tube includes a second coupler, wherein said first coupler is removably and fluidly connectable to said second coupler.

16. The frost proof sillcock of claim 15, wherein said first coupler and said second coupler are comprised of quick couplers and wherein said first coupler is rotatably connected and disconnected with respect to said second coupler.

17. The frost proof sillcock of claim 11, wherein an inner tube of said sillcock is positioned within said interior of said outer tube, wherein an exterior perimeter of said inner tube is distally spaced from an interior perimeter of said outer tube.

18. A frost proof sillcock, comprising:
an outer tube having an outer opening, fluidly connectable to a supply pipe within a building;
wherein said outer opening is exposable outside of a wall;
a sillcock removably positioned and fluidly connected within an interior of said outer tube, wherein if said sillcock incurs a ruptured opening, water flowing from the ruptured opening is diverted outside of the building through said interior of said outer tube to outwardly from said outer opening of said outer tube;
wherein said sillcock includes a first coupler and wherein said outer tube includes a second coupler, wherein said first coupler is removably and fluidly connectable to said second coupler;
wherein said first coupler is rotatably connected and disconnected with respect to said second coupler;
wherein said sillcock is comprised of a frost proof sillcock; and
a check valve fluidly connected to said outer tube, wherein said check valve is opened when said sillcock is connected to said outer tube thereby allowing water to flow from the supply pipe to said sillcock, and wherein said check valve is closed when said sillcock is disconnected from said outer tube thereby preventing water to flow from the supply pipe to said sillcock.

19. The frost proof sillcock of claim 18, including a spacer having a center opening positionable over said sillcock, a discharge opening extending downwardly, wherein said outer tube includes an inner flange, wherein said sillcock includes an outer flange and wherein said spacer is positioned between said inner flange and said outer flange.

20. The frost proof sillcock of claim 18, wherein said check valve is opened when said first coupler is connected to said second coupler thereby allowing water to flow from the supply pipe to said sillcock, and wherein said check valve is closed when said first coupler is disconnected from said second coupler thereby preventing water to flow from the supply pipe to said sillcock.
